(19) United States
(12) Patent Application Publication
(10) Pub. No.: US 2023/0022787 A1
(43) Pub. Date: Jan. 26, 2023

(54) MULTI-LAYERED CORRELATION POLICY MANAGEMENT APPARATUS AND METHOD

(71) Applicant: RAKUTEN MOBILE, INC., Tokyo (JP)

(72) Inventors: Surender Singh LAMBA, Tokyo (JP); Mihirraj Narendra DIXIT, Tokyo (JP); Abhishek SHARMA, Tokyo (JP); Bharath RATHINAM, Tokyo (JP); Rahul ATRI, Singapore (SG)

(21) Appl. No.: 17/505,631

(22) Filed: Oct. 20, 2021

Related U.S. Application Data
(60) Provisional application No. 63/223,941, filed on Jul. 20, 2021.

(51) Int. Cl. G06F 13/20; G06F 16/245

(52) U.S. Cl. CPC G06F 13/20; G06F 16/245

(57) ABSTRACT

A method includes causing a message bus to send event data received from an observability framework to one or more data enrichers based on a multi-layered correlation policy. The multi-layered correlation policy is communicated to the message bus by a policy definition manager. The policy definition manager is connected to a database that includes a plurality of rules associated with monitoring and modifying one or more network functions associated with a communication network. The policy definition manager is configured to generate the multi-layered correlation policy based on one or more of the rules. The method also includes causing a policy action manager to trigger an operation to be performed by a lifecycle manager. The operation is defined by the multi-layered correlation policy as an action caused to occur based on a determination of whether the event data satisfies one or more conditions defined by the multi-layered correlation policy.

### PRIORITY CLAIM AND CROSS-REFERENCE

This application claims priority to Provisional Application No. 63/223,941, filed Jul. 20, 2021, which is hereby incorporated by reference in its entirety.

### BACKGROUND

Network service providers and device manufacturers (e.g., wireless, cellular, etc.) are continually challenged to deliver value and convenience to consumers by, for example, providing compelling network services that are dependable and capable of being flexibly constructed, scalable and diverse.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a correlation policy application and management system, in accordance with some embodiments.

FIG. 2 is a flowchart of a process for managing and/or applying a multi-layered correlation policy, in accordance with some embodiments.

FIG. 3 is a functional block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Network services are often provided by static or inflexible systems that are difficult to configure, scale, and deploy over various target areas. Dependable network systems and/or network services that are capable of being flexibly constructed, scalable and diverse are often dependent on automating the collection, analysis and reporting of information regarding multiple network functions, network services, network devices, etc. that affect the performance, accessibility, configuration, scale, and/or deployment of a communication network, various network functions, network services, and the like.

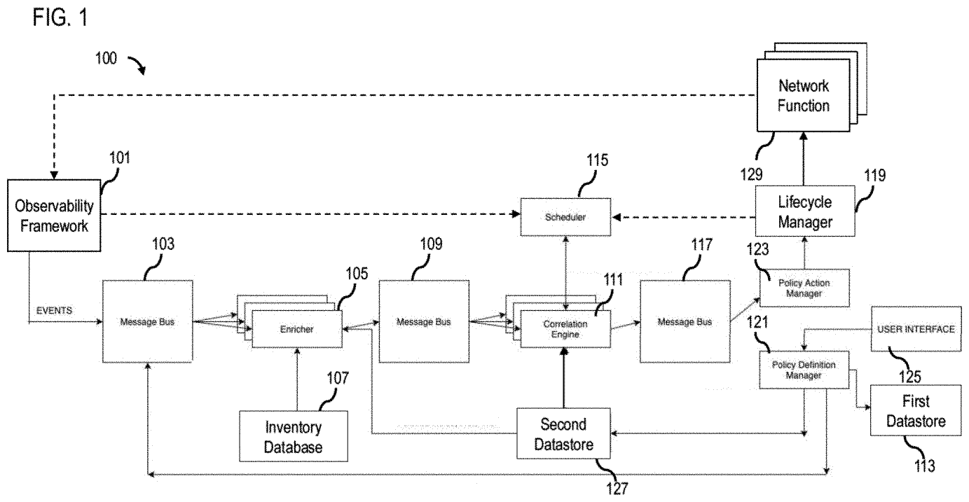

FIG. 1 is a diagram of a multi-layered correlation policy management system 100, in accordance with one or more embodiments.

The system 100 makes it possible to collect, analyse, and report information regarding multiple network functions, network services, network devices, etc. that affect the performance, accessibility, configuration, scale, and/or deployment of a communication network, various network functions, network services, and the like. In some embodiments, the system 100 causes one or more operations or actions to occur based on the analysis and/or reporting of the collected information. In some embodiments, the system 100 is configured to observe complex patterns and is capable of specifying if a group of events occur or did not occur after an event.

In some embodiments, the system 100 provides the capability for massively parallel streaming analytics, storage and fast access of data and cached information, even for topology or contextual data enrichment cache timeouts. In some embodiments, the system 100 provides an ability to setup custom functions, rules, and/or timing associated with determining compliance with one or more rules, implementing one or more rules and/or causing one or more processes to occur based on one or more rules. The system 100 is configured to minimize system resource consumption and processing times while increasing a quantity of data streams and correlation policies that are monitored and managed as compared to conventional correlation architectures that facilitate multi-stream creation and/or processing.

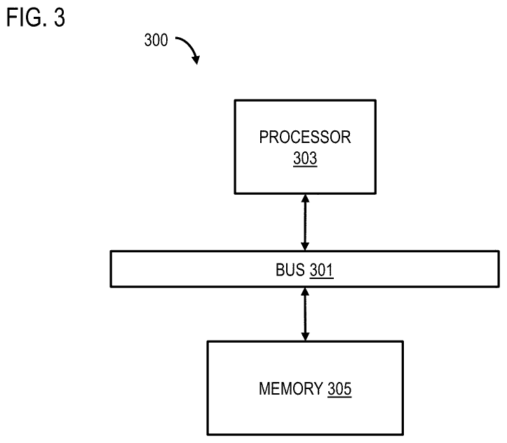

As shown in FIG. 1, the system 100 comprises an observability framework 101, a first message bus 103, one or more data enrichers 105, an inventory database 107, a second message bus 109, one or more correlation engines 111, a first datastore 113, a scheduler 115, a third message bus 117, a lifecycle manager 119, a policy definition manager 121, a policy action manager 123, a user interface 125 and a second datastore 127. It is contemplated that the functions of these components may be combined in one or more components or performed by other components of equivalent functionality. In some embodiments, various components of system 100 individually, or together, are implemented as a set of computer readable instructions that, when executed by a processor such as a processor 303 (FIG. 3), facilitates the processes discussed with respect to one or more embodiments. In some embodiments, the system 100 is a pluggable correlation architecture.

The observability framework 101 is communicatively coupled with one or more network devices, terminals, nodes, antennas, databases, operating systems, directories, firewalls, detection systems, applications, mainframes, application servers, bare metal monitor, cluster, or other suitable data source capable of generating information that can be processed into event data usable to determine a status of one or more network functions 129. The one or more network functions 129 are associated with operating a communication network. In some embodiments, a network function 129 corresponds to an operation or service performed or provided by one or more hardware components of a communication network, one or more software components of a communication network, or a combination thereof.

The observability framework 101 sends the event data to the first message bus 103. The first message bus 103 is communicatively coupled with the policy definition manager 121 and is configured to send the event data received from the observability framework 101 to the one or more data enrichers 105. The first message bus 103 is configured to send the event data to the one or more data enrichers 105 based on a multi-layered correlation policy. The multi-layered correlation policy is communicated to the first message bus 103 by the policy definition manager 121.

The policy definition manager 121 is connected to the first datastore 113 and to the second datastore 127. The first datastore 113 comprises a plurality of rules associated with monitoring and modifying the one or more network functions 129. The policy definition manager 121 is configured to generate the multi-layered correlation policy based, at least in part, on one or more of the rules stored in the first datastore 113 and cause the multi-layered correlation policy to be stored in the second datastore 127.

The one or more data enrichers 105 are configured to format the event data based on one or more of at least one template stored in the inventory database 107 or the one or more rules included in the multi-layered correlation policy stored in the second datastore 127 to generate enriched data. In some embodiments, a template is based on a set of instructions for formatting event data by one or more of aggregating, parsing, normalizing, filtering, adding, or deleting information from the event data to achieve a format defined by the template.

The second message bus 109 sends the enriched data to the one or more correlation engines 111 based on the one or more rules. In some embodiments, the second message bus 109 is excluded from the system 100 and the one or more data enrichers 105 are configured to directly send the enriched data to one or more of the correlation engines 111.

The one or more correlation engines 111 are configured to process the enriched data based on the one or more rules to determine whether the event data satisfies one or more conditions defined by the multi-layered correlation policy. The one or more correlation engines 111 are also configured to generate one or more outputs indicative of whether the event data satisfies the one or more conditions defined by the multi-layered correlation policy.

The third message bus 117 is configured to send at least one of the one or more outputs generated by the one or more correlation engines to the policy action manager 123. In some embodiments, the third message bus 117 is excluded from the system 100 and the one or more correlation engines 111 are configured to directly send a generated output to the policy action manager 123.

The policy action manager 123 is communicatively coupled with the lifecycle manager 119 and is configured to trigger an operation to be performed by the lifecycle manager 119. The operation that is performed by the lifecycle manager 119 is associated with monitoring and modifying the one or more network functions 129 based on the at least one output of the one or more outputs. In some embodiments, the operation that is performed by the lifecycle manager 119 is defined by the multi-layered correlation policy as an action caused to occur based on an outcome of the determination of whether the event data satisfies the one or more conditions defined by the multi-layered correlation policy.

In some embodiments, the multi-layered correlation policy comprises one or more unordered threshold-based conditions. The determination of whether the event data satisfies the one or more conditions defined by the multi-layered correlation policy comprises a determination that the event data includes one or more values that meet or exceed a preset threshold value of at least one of the one or more unordered threshold-based conditions.

As a non-limiting example, an unordered threshold-based condition may involve processing event data associated with determining whether a network node is up, down, or not ready. If, for example, the preset threshold values are NodeDown>=1 and NodeNotReady>=0, with a preset hold time of 10 minutes, once the preset threshold value is met or exceeded, there is no need to wait for the entire hold time, and the policy action manager 123 triggers an operation to be performed by the lifecycle manager 119.

In some embodiments, the determination that the event data includes one or more values that meet or exceed a preset threshold value of the at least one of the one or more unordered threshold-based conditions is independent from time.

In some embodiments, the policy action manager 123 is configured to trigger the operation to be performed by the lifecycle manager 119 when the determination that the event data includes one or more values that meet or exceed the preset threshold value of the at least one of the one or more unordered threshold-based conditions is made.

In some embodiments, the policy action manager 123 is configured to trigger the operation to be performed by the lifecycle manager 119 within a preset time interval from a moment the determination that the event data includes one or more values that meet or exceed the preset threshold value of the at least one of the one or more unordered threshold-based conditions is made.

As a non-limiting example, an unordered time-based condition may involve processing event data associated with determining whether a particular process associated with a network function was a success or a failure. Such a policy, for example, may involve processes F1SctpFailure and F1SctpSuccess, where preset threshold values for the processes are F1SctpFailure>1 and F1SctpSuccess<1, a preset hold time is set for 10 minutes, and a rule that defines that the policy action manager 123 should wait for an entirety of the hold time before triggering the operation to be performed by the lifecycle manager 119 when the determined value for F1SctpFailure or F1SctpSuccess is less than or equal to 1.

The scheduler 115 is communicatively coupled with the correlation engine 111. The scheduler 115 is configured to set the preset time interval based on the determination that the event data includes one or more values that meet or exceed the preset threshold value of the at least one of the one or more unordered threshold-based conditions is made.

In some embodiments, the multi-layered correlation policy comprises an instruction or data indicative of the preset time interval and the scheduler 115 is configured to cause the correlation engine 111 to communicate the preset time interval to the policy action manager 123 with the generated output. In some embodiments, the correlation engine 111 is configured to one or more of send or generate the one or more outputs based on the preset time interval communicated to the correlation engine 111 by the scheduler 115. In some embodiments, the correlation engine 111 is configured to process the enriched data based on a predefined schedule that is communicated to the correlation engine 111 one or more of by way of the scheduler 115 or the multi-layered correlation policy. In some embodiments, the scheduler 115 is communicatively coupled with the lifecycle manager 119 and with the correlation engine 111, and the scheduler 115 is configured to set the predefined schedule based on feedback received from the lifecycle manager 119. In some embodiments, the scheduler 115 is configured to set the predefined schedule based on feedback received from the observability framework 101. In some embodiments, the scheduler 115 is directly communicatively coupled with the observability framework 101 and configured to set the predefined schedule based on feedback directly received from the observability framework 101. In some embodiments, the scheduler 115 is configured to set the predefined schedule based on information included in the enriched data sent to the correlation engine 111. In some embodiments, the scheduler 115 is configured to set the predefined schedule based on feedback received from the lifecycle manager 119 and the observability framework 101. In some embodiments, the system 100 excludes the scheduler 115 and the correlation engine 111 is configured to generate the one or more outputs independent of time or the correlation engine 111 is configured to generate the one or more outputs based on information included in the enriched data.

In some embodiments, the multi-layered correlation policy comprises a first rule and a second rule, the event data comprises first event data, second event data and third event data. The policy action manager 123 is configured to determine that the event data satisfies the multi-layered correlation policy based on a determination that the first event data includes a value greater than a first preset value and the second event data includes a value greater than a second preset value. The policy action manager 123 is also configured to determine that the event data satisfies the multi-layered correlation policy based on a determination that the third event data includes a value greater than a third preset value. The policy action manager 123 is further configured to trigger the lifecycle manager 119 to cause an action corresponding to a third event corresponding to the third event data to occur based on the determination that the first event data includes the value greater than the first preset value and the second event data includes the value greater than the second preset value. The policy action manager 123 is additionally configured to trigger the lifecycle manager 119 to perform the operation based on the determination that the third event data is greater than a third preset value indicative that the action has occurred.

In some embodiments, the multi-layered correlation policy comprises one or more conditions associated with a preset order, the event data comprises two or more data points, and the determination of whether the event data satisfies the one or more conditions defined by the multi-layered correlation policy comprises a determination that the two or more data points occur in the preset order.

As a non-limiting example, an ordered condition may involve processing event data associated with determining whether a pod failure has occurred followed by a determination that a failed pod has been restarted. If, for example, Event_Pod_Failure is determined to have occurred followed by Event_Pod_Restarted, the order of events matters according to the multi-layered correlation policy, the condition is determined to be satisfied.

In some embodiments, the policy definition manager 121 is configured to generate at least one of the one or more rules, or the multi-layered correlation policy, based on a user input received by way of the user interface 125. The user interface 125 is, for example, capable of being output by way of a display associated with any of a mobile terminal, a fixed terminal, a portable terminal including a desktop computer, laptop computer, notebook computer, netbook computer, tablet computer, wearable circuitry, mobile handset, server, or combination thereof.

In some embodiments, system 100 is configured to be communicatively coupled with, or included as a component of, a network manager or end-to-end orchestrator that controls one or more workflows associated with any network function 129 comprising or associated with one or more of a network element, a network service, a slice subnet, a slice manager, a cloud management as a service (CMAAS) manager, a bare metal unit, a bare metal as a service (BMAAS) manager, a service cluster, a policy life cycle manager, a hardware switch, a field programmable gate array, an eNodeB (eNB) in 4G, an NR base station (gNB) in 5G, a virtual distributed unit (vDU) and a virtual centralized unit (vCU), which are components of a radio access network (RAN) in 4G, a DU and a CU, which are components of the RAN in 5G, a virtual RAN (VRAN), a GC, an NFP, a logic cluster, a network node, a network device, an antenna, a communication layer, or other suitable network element. In some embodiments, the one or more workflows corresponds to a type of network element and comprises one or more of an operating system installation, an upgrade, a firmware upgrade, a change in BIOS settings, or some other suitable operation or event.

In some embodiments, the correlation engine 111 determines the network is down or a network node is inoperable based on the event data and the lifecycle manager 119 is configured to output an instruction to heal the network such that the network function 129 is recognized by the observability framework 101 and the data received by the observability framework 101 is processed by the observability framework 101 and generates event data that is determined by the correlation engine 111 to satisfy the one or more conditions in the multi-layered correlation policy. In some embodiments, based on one or more rules included in the multi-layered correlation policy stored in the second datastore 127, the correlation engine 111 causes one or more event data values to be stored in the second datastore 127 for future use when determining if one or more unordered or ordered subsequent events occurs or does not occur in accordance with the conditions included in the multi-layered correlation policy.

As a non-limiting example to aid in understanding the capabilities of system 100, an implementation of a multi-layered correlation policy associated with restarting a pod is provided. In this example, the multi-layered correlation policy includes rules directed to relocating a pod and restarting a network function. The rule directed to relocating a pod includes conditions for a quantity of times the pod has been restarted, a hold time, an action code to be implemented for relocating the pod, a topology root type such as “network function,” filters such as a particular location or location range, and a defined action mode for determining an order of events or for implementing defined actions, for example, “sequence.” The rule directed to restarting the network function includes conditions for a quantity of times the pod has been relocated, a hold time, an action code such as “restart network function,” a topology root type such as “network function,” filters such as a particular location or location range, and an action mode such as “topology.”

If a kubernetes cluster associated with system 100, in this example, detects a failure of a container in a pod based on a probe signal sent to the pod by a kubernetes node in communication with the kubernetes cluster, the kubernetes node communicates the detected failure to the observability framework 101. The observability framework 101 then detects pod failures within a preset time interval. The kubernetes cluster causes the container in the pod to be restarted and determines whether the restart was successful. The kubernetes cluster then communicates the event data indicative of whether the pod container or the pod was restarted. The kubernetes node sends the probe signal to the pod to determine whether the container in the pod is active or in failure, and the kubernetes cluster reports to the observability framework 101 if the kubernetes cluster detects a subsequent failure of the container in the pod.

If the observability framework 101 detects that the quantity of pod container or pod restarts within the preset time interval exceeds a threshold value, then the lifecycle manager 119 causes the pod to be relocated to a different node by, for example, outputting a relocate pod instruction to be implemented by an end-to-end orchestrator in communication with the lifecycle manager 119 or within which the lifecycle manager 119 is included. The end-to-end orchestrator then outputs an instruction to the kubernetes cluster to restart the pod container or restart the pod, and the kubernetes cluster then restarts the pod container or restarts the pod on a different nod. In some embodiments, the correlation policy additionally includes a rule that causes the network function to be restarted based on a determination that relocating the pod container or the pod to a different node did not resolve the detected pod container or pod failure.

As another non-limiting example to aid in understanding the capabilities of system 100, an implementation of a multi-layered correlation policy associated with failing to heal a failed pod is provided. In this example, the multi-layered correlation policy includes rules directed to detecting whether a pod faulted multiple times and escalating a reported failure to an administrator. The rule directed to detecting whether a pod faulted multiple times includes conditions for a quantity of times the pod faulted, a hold time, an action code to be implemented for restarting a network function, a topology root type such as “network function,” filters such as a particular location or location range, and a defined action mode such as “topology.” The rule directed to escalating a reported failure to an administrator includes conditions for a quantity of times the pod has faulted, a hold time, an action code such as “notify administrator,” a topology root type such as “network function,” filters such as a particular location or location range, and an action mode such as “topology.”

If a kubernetes cluster associated with system 100, in this example, detects a failure of a container in a pod based on a probe signal sent to the pod by a kubernetes node in communication with the kubernetes cluster, the kubernetes cluster attempts to restart the failed pod container or pod a preset quantity of times. In some embodiments, the kubernetes cluster attempts to restart the failed pod container or pod a preset quantity of times and if unsuccessful, attempts to relocate the failed pod container or pod. In some embodiments, the kubernetes cluster concurrently attempts to restart the failed pod container or pod and attempts to relocate the failed pod container or pod. In some embodiments, the preset quantity of attempts to restart the failed pod container or the failed pod includes the attempts to relocate the failed pod container or the failed pod. In some embodiments, the kubernetes cluster attempts to separately relocate the failed pod container or the failed pod for a preset correspond quantity of times associated with relocating the failed pod container or the failed pod. If the kubernetes is unsuccessful at restarting and/or relocating the failed pod container or the failed pod within the preset quantity of attempts, the kubernetes cluster communicates event data to the observability framework 101 indicating the failure to restart and/or relocate the failed pod container or the failed pod.

The lifecycle manager 119, based on processing of the event data received by the observability framework 101, recognizes that the pod container or pod that failed to restart has resulted in a network function that is missing the failed pod container or failed pod. The lifecycle manager 119 then terminates the network function and restarts the network function by outputting a restart network function instruction to be implemented by an end-to-end orchestrator in communication with the lifecycle manager 119 or within which the lifecycle manager 119 is included. The end-to-end orchestrator then outputs an instruction to the kubernetes cluster to restart the network function. If the kubernetes cluster is unable to restart the network function, or the kubernetes cluster again detects that the pod container or the pod failed a preset quantity of times within a predefined period after restarting the network function, the kubernetes cluster communicates event data to the observability framework 101 indicating that restarting the network function did not resolve the failed pod container or the failed pod, and the lifecycle manager 119 is caused to output an alert message to a system administrator as an alarm.

In some embodiments, the one or more rules included in a multi-layered correlation policy involve one or more ordered and/or unordered sequences of events that are processed linearly or in parallel to determine the functionality of any defined network function included in a rule or combination of rules customized by a user by way of user interface 125. In some embodiments, one or more rules are processed independently or in conjunction with one another within a preset period of time.

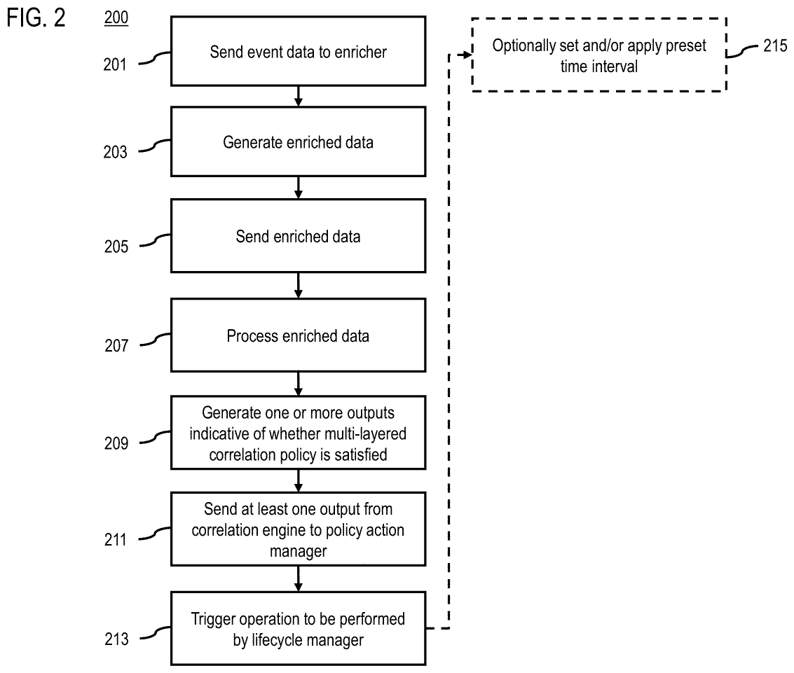

FIG. 2 is a flowchart of a process 200 for managing a multi-layered correlation policy, in accordance with one or more embodiments. In some embodiments, the system 100 (FIG. 1) performs the process 200 and is implemented in or by, for instance, a chip set including a processor and a memory as shown in FIG. 3.

In step 201, a first message bus is caused to send event data received from an observability framework to one or more data enrichers based on a multi-layered correlation policy. The multi-layered correlation policy is communicated to the first message bus by a policy definition manager. The policy definition manager has connectivity to a first database comprising a plurality of rules associated with monitoring and modifying one or more network functions associated with a communication network. The policy definition manager is configured to generate the multi-layered correlation policy based, at least in part, on one or more of the rules stored in the first database.

In step 203, the one or more data enrichers are caused to format the event data based on one or more of at least one template stored in an inventory database or the one or more rules to generate enriched data.

In step 205, a second message bus is caused to send the enriched data to one or more correlation engines based on the one or more rules.

In step 207, the one or more correlation engines are caused to process the enriched data based on the one or more rules to determine whether the event data satisfies one or more conditions defined by the multi-layered correlation policy.

In step 209, the one or more correlation engines are caused to generate one or more outputs indicative of whether the event data satisfies the one or more conditions defined by the multi-layered correlation policy.

In step 211, a third message bus is caused to send at least one output of the one or more outputs generated by and received from the one or more correlation engines to a policy action manager.

In step 213, the policy action manager is caused to trigger an operation to be performed by a lifecycle manager communicatively coupled with the policy action manager. The operation is associated with monitoring and modifying the one or more network functions based on the at least one output of the one or more outputs. The operation is defined by the multi-layered correlation policy as an action caused to occur based on an outcome of the determination of whether the event data satisfies the one or more conditions defined by the multi-layered correlation policy.

In some embodiments, the multi-layered correlation policy comprises one or more unordered threshold-based conditions, and the determination of whether the event data satisfies the one or more conditions defined by the multi-layered correlation policy comprises a determination that the event data includes one or more values that meet or exceed a preset threshold value of at least one of the one or more unordered threshold-based conditions.

In some embodiments, the determination that the event data includes one or more values that meet or exceed a preset threshold value of the at least one of the one or more unordered threshold-based conditions is independent from time.

In some embodiments, the policy action manager is configured to trigger the operation to be performed by the lifecycle manager when the determination that the event data includes one or more values that meet or exceed the preset threshold value of the at least one of the one or more unordered threshold-based conditions is made.

In some embodiments, the policy action manager is configured to trigger the operation to be performed by the lifecycle manager within a preset time interval from a moment the determination that the event data includes one or more values that meet or exceed the preset threshold value of the at least one of the one or more unordered threshold-based conditions is made.

In optional step 215, a scheduler communicatively coupled with the correlation engine is caused to set the preset time interval. In some embodiments, the scheduler is caused to set the preset time interval based on the determination that the event data includes one or more values that meet or exceed the preset threshold value of the at least one of the one or more unordered threshold-based conditions is made. In some embodiments, the scheduler is caused to set the preset time interval based on feedback received from at least one of the lifecycle manager or the observability framework.

In some embodiments, the multi-layered correlation policy comprises one or more sequence conditions, the event data comprises two or more data points, and the determination of whether the event data satisfies the one or more conditions defined by the multi-layered correlation policy comprises a determination that the two or more data points occur in a preset order.

In some embodiments, the correlation engine is caused to process the enriched data based on a predefined schedule.

In some embodiments, the multi-layered correlation policy comprises a first rule and a second rule, the event data comprises first event data, second event data and third event data. The policy action manager is configured to determine that the event data satisfies the multi-layered correlation policy based on a determination that the first event data includes a value greater than a first preset value and the second event data includes a value greater than a second preset value, the policy action manager is configured to determine that the event data satisfies the multi-layered correlation policy based on a determination that the third event data includes a value greater than a third preset value, the policy action manager is configured to trigger the lifecycle manager to cause an action corresponding to a third event corresponding to the third event data to occur based on the determination that the first event data includes the value greater than the first preset value and the second event data includes the value greater than the second preset value, and/or the policy action manager is configured to trigger the lifecycle manager to perform the operation based on the determination that the third event data is greater than a third preset value indicative that the action has occurred. In some embodiments, the policy definition manager is configured to generate at least one of the one or more rules or the multi-layered correlation policy based on a user input received by way of a user interface.

FIG. 3 is a functional block diagram of a computer or processor-based system 300 upon which or by which an embodiment is implemented.

Processor-based system 300 is programmed to manage and/or apply a multi-layered correlation policy, as described herein, and includes, for example, bus 301, processor 303, and memory 305 components.

In some embodiments, the processor-based system is implemented as a single “system on a chip.” Processor-based system 300, or a portion thereof, constitutes a mechanism for performing one or more steps of managing and/or applying a multi-layered correlation policy.

In some embodiments, the processor-based system 300 includes a communication mechanism such as bus 301 for transferring information and/or instructions among the components of the processor-based system 300. Processor 303 is connected to the bus 301 to obtain instructions for execution and process information stored in, for example, the memory 305. In some embodiments, the processor 303 is also accompanied with one or more specialized components to perform certain processing functions and tasks such as one or more digital signal processors (DSP), and/or one or more application-specific integrated circuits (ASIC). A DSP typically is configured to process real-world signals (e.g., sound) in real time independently of the processor 303. Similarly, an ASIC is configurable to perform specialized functions not easily performed by a more general purpose processor. Other specialized components to aid in performing the functions described herein optionally include one or more field programmable gate arrays (FPGA), one or more controllers, and/or one or more other special-purpose computer chips.

In one or more embodiments, the processor (or multiple processors) 303 performs a set of operations on information as specified by a set of instructions stored in memory 305 related to managing and/or applying a multi-layered correlation policy. The execution of the instructions causes the processor to perform specified functions.

The processor 303 and accompanying components are connected to the memory 305 via the bus 301. The memory 305 includes one or more of dynamic memory (e.g., RAM, magnetic disk, writable optical disk, etc.) and static memory (e.g., ROM, CD-ROM, etc.) for storing executable instructions that when executed perform the steps described herein to manage and/or apply a multi-layered correlation policy. The memory 305 also stores the data associated with or generated by the execution of the steps.

In one or more embodiments, the memory 305, such as a random access memory (RAM) or any other dynamic storage device, stores information including processor instructions for managing and/or applying a multi-layered correlation policy. Dynamic memory allows information stored therein to be changed. RAM allows a unit of information stored at a location called a memory address to be stored and retrieved independently of information at neighboring addresses. The memory 305 is also used by the processor 303 to store temporary values during execution of processor instructions. In various embodiments, the memory 305 is a read only memory (ROM) or any other static storage device coupled to the bus 301 for storing static information, including instructions, that is not capable of being changed by processor 303. Some memory is composed of volatile storage that loses the information stored thereon when power is lost. In some embodiments, the memory 305 is a non-volatile (persistent) storage device, such as a magnetic disk, optical disk or flash card, for storing information, including instructions, that persists even when the system 300 is turned off or otherwise loses power.

The term “computer-readable medium” as used herein refers to any medium that participates in providing information to processor 303, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

In one aspect, a method, includes causing, by a processor, a first message bus to send event data received from an observability framework to one or more data enrichers based on a multi-layered correlation policy, the multi-layered correlation policy being communicated to the first message bus by a policy definition manager, the policy definition manager having connectivity to a first database includes a plurality of rules associated with monitoring and modifying one or more network functions associated with a communication network, where the policy definition manager is configured to generate the multi-layered correlation policy based, at least in part, on one or more of the rules stored in the first database. The method also includes causing the one or more data enrichers to format the event data based on one or more of at least one template stored in an inventory database or the one or more rules to generate enriched data. The method also includes causing a second message bus to send the enriched data to one or more correlation engines based on the one or more rules. The method also includes causing the one or more correlation engines to process the enriched data based on the one or more rules to determine whether the event data satisfies one or more conditions defined by the multi-layered correlation policy, and causing the one or more correlation engines to generate one or more outputs indicative of whether the event data satisfies the one or more conditions defined by the multi-layered correlation policy. The method also includes causing a third message bus to send at least one output of the one or more outputs generated by and received from the one or more correlation engines to a policy action manager. The method also includes causing the policy action manager to trigger an operation to be performed by a lifecycle manager communicatively coupled with the policy action manager, the operation being associated with monitoring and modifying the one or more network functions based on the at least one output of the one or more outputs, the operation being defined by the multi-layered correlation policy as an action caused to occur based on an outcome of the determination of whether the event data satisfies the one or more conditions defined by the multi-layered correlation policy.

In another aspect, an apparatus includes a processor. The apparatus also includes a memory storing instructions that, when executed by the processor, cause the apparatus to cause a first message bus to send event data received from an observability framework to one or more data enrichers based on a multi-layered correlation policy, the multi-layered correlation policy being communicated to the first message bus by a policy definition manager, the policy definition manager having connectivity to a first database includes a plurality of rules associated with monitoring and modifying one or more network functions associated with a communication network, where the policy definition manager is configured to generate the multi-layered correlation policy based, at least in part, on one or more of the rules stored in the first database. The apparatus is also caused to cause the one or more data enrichers to format the event data based on one or more of at least one template stored in an inventory database or the one or more rules to generate enriched data. The apparatus is also caused to cause a second message bus to send the enriched data to one or more correlation engines based on the one or more rules. The apparatus is also caused to cause the one or more correlation engines to process the enriched data based on the one or more rules to determine whether the event data satisfies one or more conditions defined by the multi-layered correlation policy, and to cause the one or more correlation engines to generate one or more outputs indicative of whether the event data satisfies the one or more conditions defined by the multi-layered correlation policy. The apparatus is also caused to cause a third message bus to send at least one output of the one or more outputs generated by and received from the one or more correlation engines to a policy action manager. The apparatus is also caused to cause the policy action manager to trigger an operation to be performed by a lifecycle manager communicatively coupled with the policy action manager, the operation being associated with monitoring and modifying the one or more network functions based on the at least one output of the one or more outputs, the operation being defined by the multi-layered correlation policy as an action caused to occur based on an outcome of the determination of whether the event data satisfies the one or more conditions defined by the multi-layered correlation policy.

In another aspect, a non-transitory computer-readable storage medium includes instructions that, when executed by a processor, cause an apparatus to cause a first message bus to send event data received from an observability framework to one or more data enrichers based on a multi-layered correlation policy, the multi-layered correlation policy being communicated to the first message bus by a policy definition manager, the policy definition manager having connectivity to a first database includes a plurality of rules associated with monitoring and modifying one or more network functions associated with a communication network, where the policy definition manager is configured to generate the multi-layered correlation policy based, at least in part, on one or more of the rules stored in the first database. The apparatus is also caused to cause the one or more data enrichers to format the event data based on one or more of at least one template stored in an inventory database or the one or more rules to generate enriched data. The apparatus is also caused to cause a second message bus to send the enriched data to one or more correlation engines based on the one or more rules. The apparatus is also caused to cause the one or more correlation engines to process the enriched data based on the one or more rules to determine whether the event data satisfies one or more conditions defined by the multi-layered correlation policy, and to cause the one or more correlation engines to generate one or more outputs indicative of whether the event data satisfies the one or more conditions defined by the multi-layered correlation policy. The apparatus is also caused to cause a third message bus to send at least one output of the one or more outputs generated by and received from the one or more correlation engines to a policy action manager. The apparatus is also caused to cause the policy action manager to trigger an operation to be performed by a lifecycle manager communicatively coupled with the policy action manager, the operation being associated with monitoring and modifying the one or more network functions based on the at least one output of the one or more outputs, the operation being defined by the multi-layered correlation policy as an action caused to occur based on an outcome of the determination of whether the event data satisfies the one or more conditions defined by the multi-layered correlation policy.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
causing, by a processor, a first message bus to send event data received from an observability framework to one or more data enrichers based on a multi-layered correlation policy, the multi-layered correlation policy being communicated to the first message bus by a policy definition manager, the policy definition manager having connectivity to a first database comprising a plurality of rules associated with monitoring and modifying one or more network functions associated with a communication network, wherein the policy definition manager is configured to generate the multi-layered correlation policy based, at least in part, on one or more of the rules stored in the first database;
causing the one or more data enrichers to format the event data based on one or more of at least one template stored in an inventory database or the one or more rules to generate enriched data;
causing a second message bus to send the enriched data to one or more correlation engines based on the one or more rules;
causing the one or more correlation engines to:
process the enriched data based on the one or more rules to determine whether the event data satisfies one or more conditions defined by the multi-layered correlation policy; and
generate one or more outputs indicative of whether the event data satisfies the one or more conditions defined by the multi-layered correlation policy;
causing a third message bus to send at least one output of the one or more outputs generated by and received from the one or more correlation engines to a policy action manager;
causing the policy action manager to trigger an operation to be performed by a lifecycle manager communicatively coupled with the policy action manager, the operation being associated with monitoring and modifying the one or more network functions based on the at least one output of the one or more outputs, the operation being defined by the multi-layered correlation policy as an action caused to occur based on an outcome of the determination of whether the event data satisfies the one or more conditions defined by the multi-layered correlation policy.

2. The method of claim 1, wherein the multi-layered correlation policy comprises one or more unordered threshold-based conditions, and the determination of whether the event data satisfies the one or more conditions defined by the multi-layered correlation policy comprises a determination that the event data includes one or more values that meet or exceed a preset threshold value of at least one of the one or more unordered threshold-based conditions.

3. The method of claim 2, wherein the determination that the event data includes one or more values that meet or exceed a preset threshold value of the at least one of the one or more unordered threshold-based conditions is independent from time.

4. The method of claim 3, wherein the policy action manager is configured to trigger the operation to be performed by the lifecycle manager when the determination that the event data includes one or more values that meet or exceed the preset threshold value of the at least one of the one or more unordered threshold-based conditions is made.

5. The method of claim 3, wherein the policy action manager is configured to trigger the operation to be performed by the lifecycle manager within a preset time interval from a moment the determination that the event data includes one or more values that meet or exceed the preset threshold value of the at least one of the one or more unordered threshold-based conditions is made.

6. The method of claim 5, further comprising:
causing a scheduler communicatively coupled with the correlation engine to set the preset time interval based on the determination that the event data includes one or more values that meet or exceed the preset threshold value of the at least one of the one or more unordered threshold-based conditions is made.

7. The method of claim 1, wherein the multi-layered correlation policy comprises one or more conditions associated with a preset order, the event data comprises two or more data points, and the determination of whether the event data satisfies the one or more conditions defined by the multi-layered correlation policy comprises a determination that the two or more data points occur in the preset order.

8. The method of claim 1, wherein the correlation engine is caused to process the enriched data based on a predefined schedule.

9. The method of claim 8, further comprising:
causing a scheduler communicatively coupled with the correlation engine to set the predefined schedule based on feedback received from at least one of the lifecycle manager or the observability framework.

10. The method of claim 8, wherein
the multi-layered correlation policy comprises a first rule and a second rule, the event data comprises first event data, second event data and third event data,
the policy action manager is configured to determine that the event data satisfies the multi-layered correlation policy based on a determination that the first event data includes a value greater than a first preset value and the second event data includes a value greater than a second preset value,
the policy action manager is configured to determine that the event data satisfies the multi-layered correlation policy based on a determination that the third event data includes a value greater than a third preset value,
the policy action manager is configured to trigger the lifecycle manager to cause an action corresponding to a third event corresponding to the third event data to occur based on the determination that the first event data includes the value greater than the first preset value and the second event data includes the value greater than the second preset value, and
the policy action manager is configured to trigger the lifecycle manager to perform the operation based on the determination that the third event data is greater than the third preset value indicative that the action has occurred.

11. The method of claim 1, the policy definition manager is configured to generate at least one of the one or more rules or the multi-layered correlation policy based on a user input received by way of a user interface.

12. A apparatus comprising:
a processor; and
a memory storing instructions that, when executed by the processor, cause the apparatus to:
cause a first message bus to send event data received from an observability framework to one or more data enrichers based on a multi-layered correlation policy, the multi-layered correlation policy being communicated to the first message bus by a policy definition manager, the policy definition manager having connectivity to a first database comprising a plurality of rules associated with monitoring and modifying one or more network functions associated with a communication network, wherein the policy definition manager is configured to generate the multi-layered correlation policy based, at least in part, on one or more of the rules stored in the first database;
cause the one or more data enrichers to format the event data based on one or more of at least one template stored in an inventory database or the one or more rules to generate enriched data;
cause a second message bus to send the enriched data to one or more correlation engines based on the one or more rules;
cause the one or more correlation engines to:
process the enriched data based on the one or more rules to determine whether the event data satisfies one or more conditions defined by the multi-layered correlation policy; and
generate one or more outputs indicative of whether the event data satisfies the one or more conditions defined by the multi-layered correlation policy;
cause a third message bus to send at least one output of the one or more outputs generated by and received from the one or more correlation engines to a policy action manager;
cause the policy action manager to trigger an operation to be performed by a lifecycle manager communicatively coupled with the policy action manager, the operation being associated with monitoring and modifying the one or more network functions based on the at least one output of the one or more outputs, the operation being defined by the multi-layered correlation policy as an action caused to occur based on an outcome of the determination of whether the event data satisfies the one or more conditions defined by the multi-layered correlation policy.

13. The apparatus of claim 12, wherein the multi-layered correlation policy comprises one or more unordered threshold-based conditions, and the determination of whether the event data satisfies the one or more conditions defined by the multi-layered correlation policy comprises a determination that the event data includes one or more values that meet or exceed a preset threshold value of at least one of the one or more unordered threshold-based conditions.

14. The apparatus of claim 13, wherein the determination that the event data includes one or more values that meet or exceed a preset threshold value of the at least one of the one or more unordered threshold-based conditions is independent from time.

15. The apparatus of claim 14, wherein the policy action manager is configured to trigger the operation to be performed by the lifecycle manager when the determination that the event data includes one or more values that meet or exceed the preset threshold value of the at least one of the one or more unordered threshold-based conditions is made.

16. The apparatus of claim 14, wherein the policy action manager is configured to trigger the operation to be performed by the lifecycle manager within a preset time interval from a moment the determination that the event data includes one or more values that meet or exceed the preset threshold value of the at least one of the one or more unordered threshold-based conditions is made.

17. The apparatus of claim 16, wherein the apparatus is further caused to:
cause a scheduler communicatively coupled with the correlation engine to set the preset time interval based on the determination that the event data includes one or more values that meet or exceed the preset threshold value of the at least one of the one or more unordered threshold-based conditions is made.

18. The apparatus of claim 12, wherein the multi-layered correlation policy comprises one or more conditions associated with a preset order, the event data comprises two or more data points, and the determination of whether the event data satisfies the one or more conditions defined by the multi-layered correlation policy comprises a determination that the two or more data points occur in the preset order.

19. The apparatus of claim 12, wherein the correlation engine is caused to process the enriched data based on a predefined schedule, and the apparatus is further caused to:
cause a scheduler communicatively coupled with the correlation engine to set the predefined schedule based on feedback received from at least one of the lifecycle manager or the observability framework.

20. A non-transitory computer-readable storage medium including instructions that, when executed by a processor, cause an apparatus to:
cause a first message bus to send event data received from an observability framework to one or more data enrichers based on a multi-layered correlation policy, the multi-layered correlation policy being communicated to the first message bus by a policy definition manager, the policy definition manager having connectivity to a first database comprising a plurality of rules associated with monitoring and modifying one or more network functions associated with a communication network, wherein the policy definition manager is configured to generate the multi-layered correlation policy based, at least in part, on one or more of the rules stored in the first database;
cause the one or more data enrichers to format the event data based on one or more of at least one template stored in an inventory database or the one or more rules to generate enriched data;
cause a second message bus to send the enriched data to one or more correlation engines based on the one or more rules;
cause the one or more correlation engines to:
process the enriched data based on the one or more rules to determine whether the event data satisfies one or more conditions defined by the multi-layered correlation policy; and
generate one or more outputs indicative of whether the event data satisfies the one or more conditions defined by the multi-layered correlation policy;
cause a third message bus to send at least one output of the one or more outputs generated by and received from the one or more correlation engines to a policy action manager;
cause the policy action manager to trigger an operation to be performed by a lifecycle manager communicatively coupled with the policy action manager, the operation being associated with monitoring and modifying the one or more network functions based on the at least one output of the one or more outputs, the operation being defined by the multi-layered correlation policy as an action caused to occur based on an outcome of the determination of whether the event data satisfies the one or more conditions defined by the multi-layered correlation policy.
